(19) United States
(12) Patent Application Publication
(10) Pub. No.: US 2002/0074927 A1
(43) Pub. Date: Jun. 20, 2002

(54) Color display device with a deflection-dependent distance between outer beams

(76) Inventors: Heidrun Steinhauser, Eindhoven (NL); Ronald Johannes Gelten, Eindhoven (NL)

Correspondence Address: Corporate Patent Counsel, U.S. Philips Corporation, 580 White Plains Road, Tarrytown, NY, 10591, US

(21) Appl. No.: 10/014,187

(22) Filed: Dec. 11, 2001

(30) Foreign Application Priority Data
Dec. 18, 2000 (EP) 00204635.7

(51) Int. Cl. H01J 29/56

(52) U.S. Cl. 313/414

(57) ABSTRACT

A color display device comprises an electron gun, a display screen and a flat color selection electrode as well as a deflection means. The distance between the electron beams is dynamically varied, whereby the distance in the deflection space decreases as the beams are deflected in at least one direction. The reduction of the distance enables the distance between the color selection electrode and the display screen to be increased in that direction. As a result, the curvature of the inner surface of the color selection electrode may be increased, which has a positive effect on the strength and doming behavior of the color selection electrode.

The invention relates to a color display device comprising a color cathode ray tube including an in-line electron gun for generating three electron beams, a color selection electrode and a phosphor screen on an inner surface of a display window, and a means for deflecting the electron beams across the color selection electrode, the color display device comprising means for dynamically influencing the paths of the electron beams so as to decrease, as a function of the deflection in the at least one direction, the distance between the electron beams at the location of the deflection plane, said means comprising at some distance from each other a first and a second means for dynamically influencing the distance between the electron beams, the influences of the first and second means being of opposite sign.

Such devices are known from international patent application no. WO 99/34392.

The general aim of manufacturers of cathode ray tube display devices is to make the outer surface of the display window flatter, so that the image represented by the color display device is perceived by the viewer as being flat. However, an increase of the radius of curvature of the outer surface of the display device will lead to an increase of a number of problems. The radius of curvature of the inner surface of the display window and of the color selection electrode should also increase, and, as the color selection electrode becomes flatter, the strength of the color selection electrode decreases and hence the sensitivity to doming and vibrations increases. A possible solution to this problem would be to curve the inner surface of the display window more strongly than the outer surface. By virtue thereof, a shadow mask having a relatively small radius of curvature (i.e. large curvature) can be used. As a result, doming and vibration problems are reduced, but other problems occur instead. The thickness of the display window is much smaller in the center than at the edges. As a result, the weight of the display window increases and the intensity of the image decreases substantially towards the edges.

A partial solution to these problems is described in international patent application no. WO 99/34392, in which a color display device is described, which device comprises means for dynamically influencing the paths of the electron beams so as to decrease, as a function of the deflection in the at least one direction, the distance between the electron beams at the location of the deflection plane.

By virtue of the presence of the means, the distance between the electron beams (also referred to as “gun pitch”) in the plane of deflection can be changed dynamically in such a manner that this distance decreases as the deflection increases. By dynamically changing this distance as a function of the deflection, and hence as a function of the x and/or y-coordinate(s), the distance between the display window and the color selection electrode can increase accordingly in the relevant deflection direction. The shape of the inner surface of the display window and the distance between the display window and the color selection electrode determine the shape, in particular the curvature, of the color selection electrode. Since the distance between the electron beams in the plane of deflection decreases as a function of the deflection, the distance between the display window and the color selection electrode increases, and the shape of the color selection electrode can deviate more from the shape of the inner surface of the display window than in known cathode ray tubes, and, in particular, its curvature can be increased.

The known pitch control means comprise a first and a second pitch control means, at some distance from each other. One of these means increases the distance between the outer electron beams as a function of the deflection, while the other has the opposite effect. Using two pitch control means allows a better control of the change in pitch and enables the pitch at the deflection plane to be influenced in such a manner that the convergence of the electron beams is better controllable. In an embodiment shown in WO 99/34392, the first and second pitch control means are formed by parts of the electron gun, with two electric dynamic quadrupolar fields being generated in operation. A field Q2 is formed between grids G2 and G3, and a field Q1 is formed between the main lens electrodes.

Although the known solution provides a partial solution, problems remain. In particular, a separate dynamic voltage is to be applied to either the G2 or G3 electrode. Application of a dynamic voltage requires a separate leadthrough and a separate power supply dedicated to this effect. However, the added cost and complexity are a barrier to the introduction of this solution.

It is an object of the invention to at least partially remove this barrier.

To this end, the display device in accordance with the invention is characterized in that the electron gun comprises a prefocusing section comprising at least a first and a second prefocusing electrode at fixed potentials, a main lens section having at least a main lens electrode at anode potential, and a fixed focusing potential section between the prefocusing section and the main lens electrode at anode potential, the electron gun comprising a first dynamic potential electrode between the second prefocusing electrode and the fixed focusing potential section and a second dynamic potential electrode between the fixed focusing potential section and the main lens electrode at anode potential, the first and second dynamic potential electrodes being electrically interconnected, and the display device having means for applying a single dynamic voltage for the first and second dynamic potential electrodes to form the first and second means for dynamically influencing the distance between the electron beams at the plane of deflection, the second means also dynamically influencing focus and astigmatism of the main lens.

Only a single dynamic voltage is then used for dynamically (i.e. as a function of deflection) controlling focusing and astigmatism (guns having such control means are used in particular for high-quality devices) and dynamically controlling the gun pitch. The single dynamic voltage, the use of which is well known to setmakers, does not require important changes in design or addition of an extra feedthrough and supply.

In some embodiments, the display screen is rectangular with a long and a short axes, and the at least one direction corresponds to the long axes. The single dynamic signal then has a component which corresponds to (is a function of) the deflection along the long axes. In standard tubes, this is the line (fast) direction. Such embodiments are preferred in standard tubes (i.e. tubes in which the line direction corresponds to the long axes) in which the need for DAF is relatively large, but the need for gun pitch modulation is relatively small. In standard tubes, the need for DAF correction is often greater along the long axes (line-frequent), and the need for gun pitch modulation is greater along the short (frame-frequent) axes. In a further preferred embodiment, the at least one direction corresponds to the long axes, and the line deflection (the fast high-frequency deflection) is along a direction corresponding to the short axes. In such tubes (of the so-called transposed scan, because the scan directions are transposed), the need for DAF correction and gun pitch modulation are both strongest along the long axes, which in these transposed scan tubes corresponds to the slow, frame-frequent axes. Thus, in such transposed scan tubes, the invention can be used very advantageously because in such tubes both the gun pitch modulation (GPM) and the dynamic astigmatism and focusing (DAF) are primarily frame-frequent, i.e. primarily dependent on the deflection in the frame, slow direction, i.e. along the long axes.

In other embodiments, the display screen is rectangular with a long and a short axes, and the at least one direction corresponds to the short axes. Such embodiments are preferred in standard tubes (i.e. tubes in which the (fast) line direction corresponds to the long axes) in which the need for DAF is relatively small but the need for gun pitch modulation is relatively moderate.

In yet other embodiments, the applied dynamic voltage comprises components corresponding to the deflection along the short and long axes, and is directly applied to the main lens, the electric connection between the first and the second dynamic potential electrode including a low-pass filter, inside the tube. Dynamic astigmatism and focusing correction is then done both along the short and the long axes, while gun pitch modulation is done along the long axes.

The electron gun preferably comprises, between the first dynamic potential electrode and the second electrode at fixed potential of the pre-focusing section, an intermediate electrode which, in operation, is at the same potential as the fixed focusing potential section, a multiple of pitch-influencing means being formed between the intermediate electrode, the first dynamic potential electrode and the fixed focusing potential section.

The first dynamic potential means are split into two or more submeans. The use of multiple pitch-influencing means prior to the fixed focusing potential section enables the point of deflection of the electron beams due to said multiple pitch-influencing means to be controlled, which more in particular said point is preferably fixed to substantially coincide with the cross-over points of the electron beams.

The main lens images the cross-over of the electron beams on the screen. Beam angle changes in the cross-over (the object) will not change the convergence of the electron beams on the screen (the image). Thus, by situating the point of deflection close to or at the cross-over, only a small correction needs to be made by the second means.

These and other objects of the invention are apparent from and will be elucidated with reference to the embodiments described hereinafter.

In the drawings:

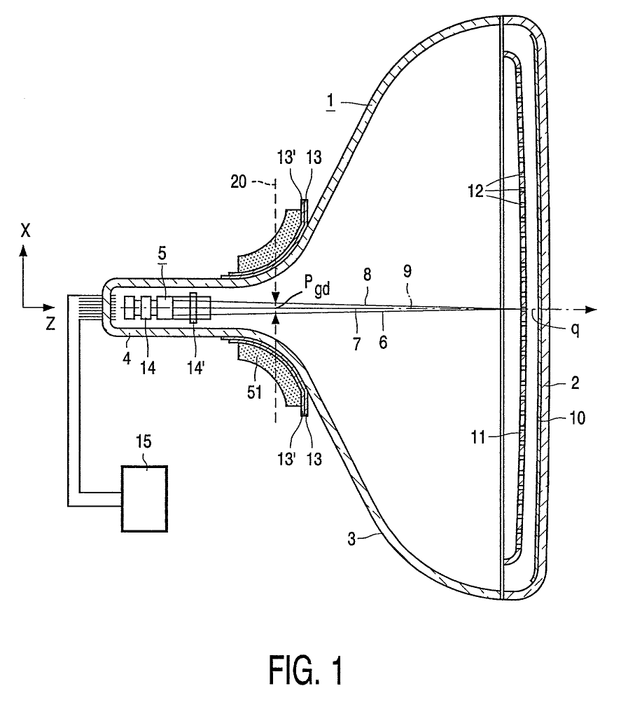

FIG. 1 is a sectional view of a display device, in which the invention is schematically shown;

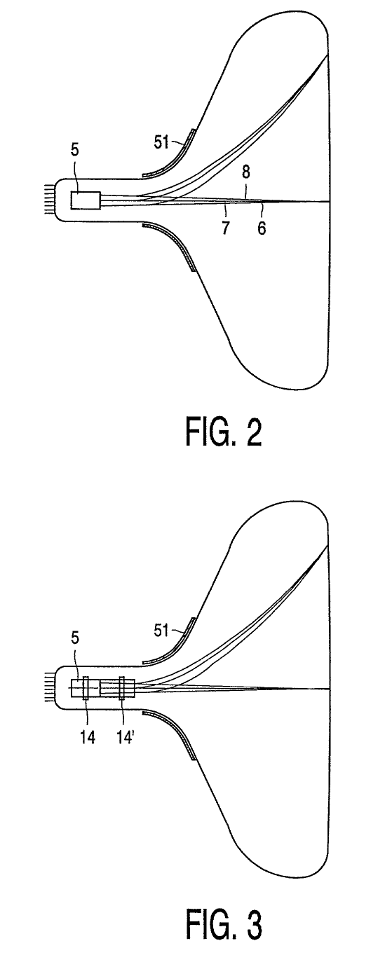

FIGS. 2 and 3 show, by means of schematic, sectional views of color display devices, a number of recognitions on which the invention is based;

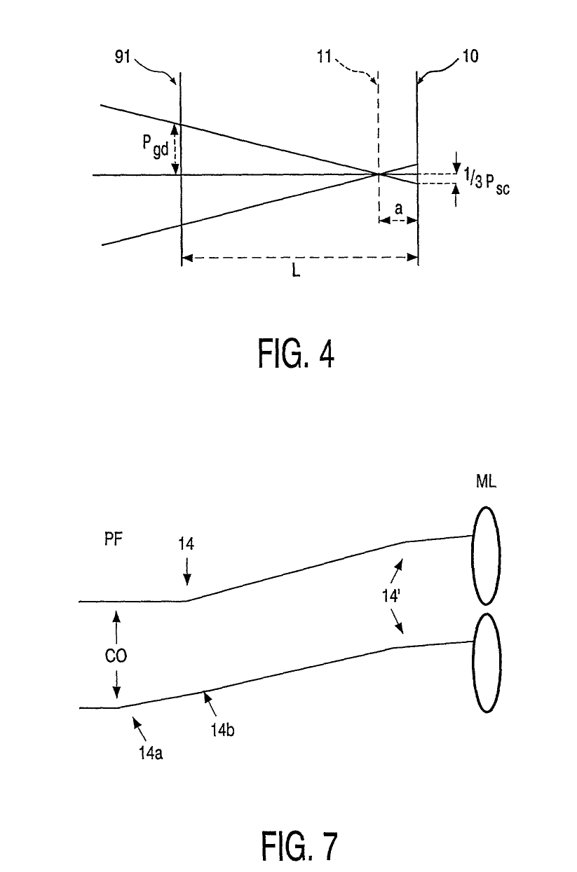

FIG. 4 shows the relation between the gun pitch, the screen pitch P_{sc}, the distance L between the deflection plane and the screen, and the distance q between the shadow mask and the screen.

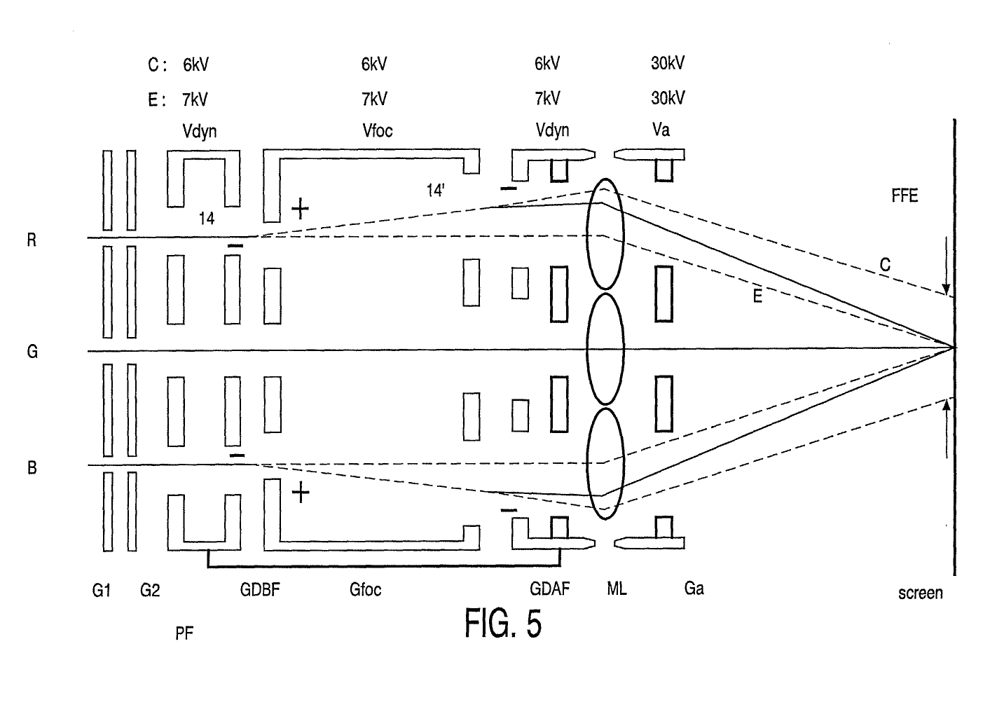

FIG. 5 illustrates an electron gun for a display device in accordance with the invention.

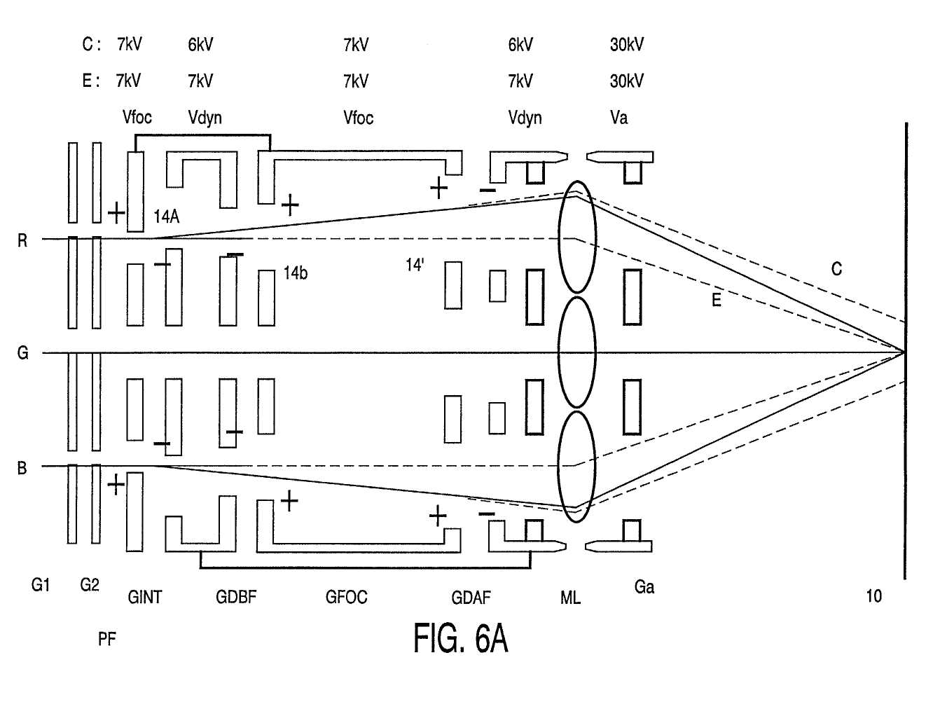

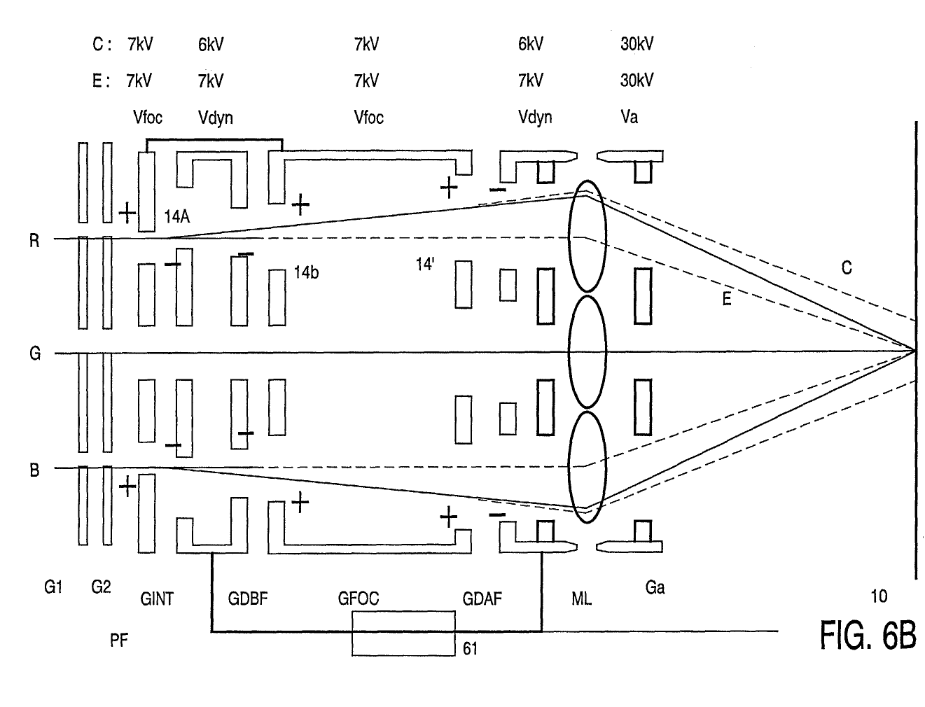

FIG. 6A illustrates a preferred embodiment of a display device in accordance with the invention.

FIG. 6B illustrates a preferred embodiment of a display device in accordance with the invention.

FIG. 7 illustrates the effects of splitting the first means into two submeans.

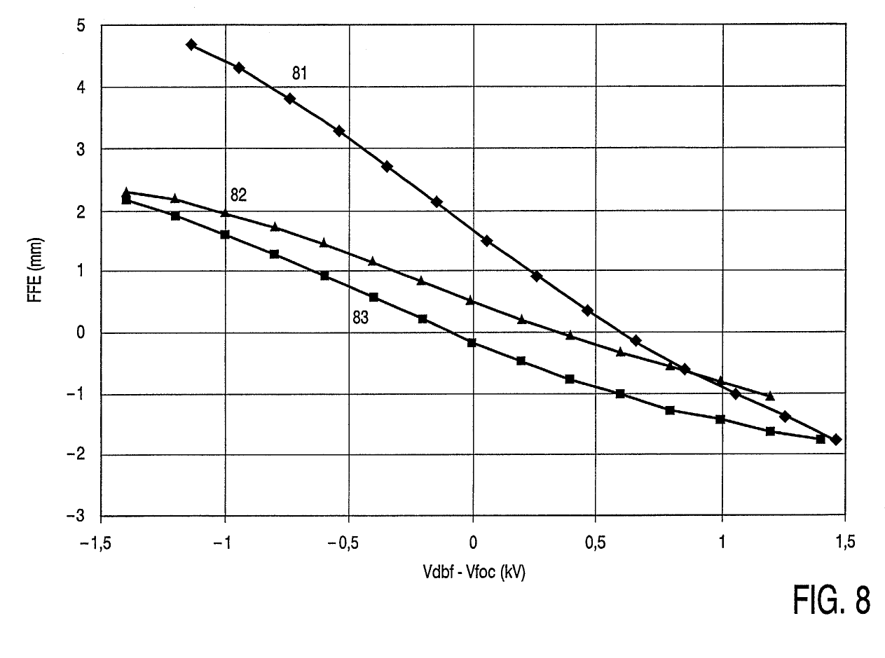

FIG. 8 schematically illustrates the relation between free-fall error and V_{DBF}-V_{foc}.

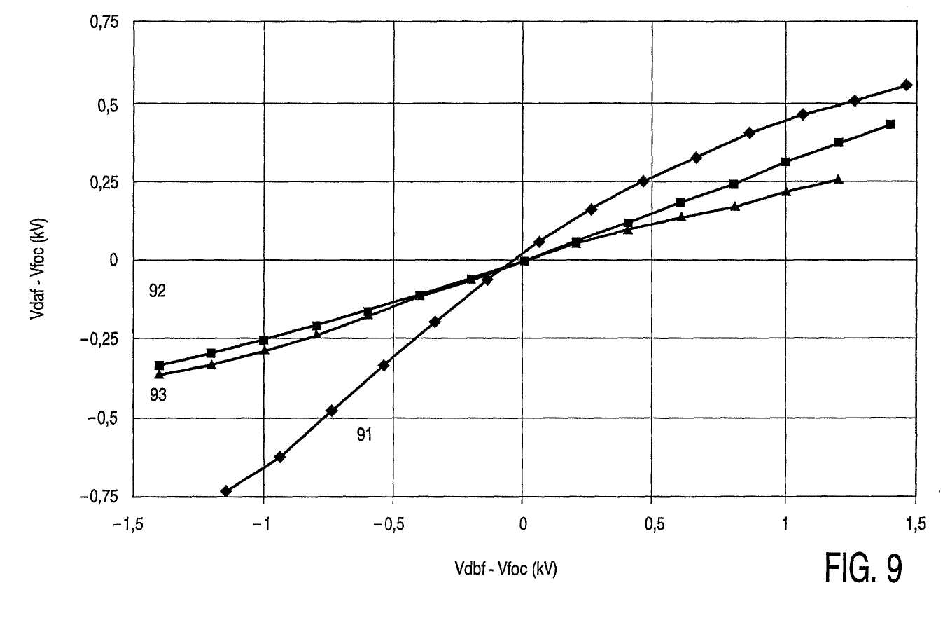

FIG. 9 schematically shows the relation between V_{DBF}-V_{foc} and V_{DAF}-V_{foc}.

The FIGS. are not drawn to scale. In the FIGS., like reference numerals generally refer to like parts.

The display device comprises a cathode ray tube, in this example a color display tube, having an evacuated envelope 1 which includes a display window 2, a cone portion 3 and a neck 4. The neck 4, accommodates an electron gun 5 for generating three electron beams 6, 7 and 8 which extend in one plane, the in-line plane, which in this case is the plane of the drawing. In the undeflected state, the central electron beam 7 substantially coincides with the tube axes 9. The inner surface of the display window is provided with a display screen 10. Said display screen 10 comprises a large number of phosphor elements luminescent in red, green and blue. On their way to the display screen, the electron beams are deflected across the display screen 10 by means of an electromagnetic deflection unit 51 and pass through a color selection electrode 11 which is arranged in front of the display window 2 and comprises a thin plate having apertures 12. The three electron beams 6, 7 and 8 pass through the aperture 12 of the color selection electrode at a small angle relative to each other and hence each electron beam impinges only on phosphor elements of one color.

In addition to a coil holder 13, the deflection unit 51 comprises coils 13′ for deflecting the electron beams in two mutually perpendicular directions. The display device further includes means for generating voltages which, during operation, are fed to components of the electron gun via feedthroughs. The deflection plane 20 is schematically indicated as well as the distance P_{gd} between the electron beams 6 and 8 in this plane, and the distance q between the color selection electrode and the display screen. The display device is provided with means 15 for supplying voltages to the electron gun 5 via feedthroughs in the neck.

The color display device comprises two means 14, 14′, a means 14 being used, in operation, to dynamically bend, i.e. as a function of the deflection in a direction, the outermost electron beams 6, 8 away from each other, and a further means 14′ being used to dynamically bend the outermost electron beams in opposite directions.

FIG. 1 schematically shows these effects. The three electron beams 6, 7 and 8 are separated from each other in the plane of deflection (a plane 20 which is situated approximately in the center of the deflection unit 11) by a distance P_{gd}. The distance q between the color selection electrode 12 and the display screen 10 is inversely proportional to the distance P_{gd}. In a formula, this can be expressed as follows:

q=CP_{gd}⁻¹, where C is a constant.

Consequently by decreasing the distance P_{gd} as a function of the deflection, the distance q can be increased accordingly. This enables the shadow mask to be more curved (i.e. to have a smaller radius of curvature) than the inner side of the display window.

The color display device in accordance with the embodiment of the invention shown in FIG. 1 comprises two means (14, 14′), which are positioned at some distance from each other and are used to vary the distance P_{gd}, as a function of the deflection, in such a manner that this distance P_{gd} decreases as a function of the deflection in at least one direction. Each of said means is integrated in the electron gun.

This effect is illustrated in FIGS. 3 and 4. FIG. 3 shows a color display device without the means 14, 14′. The distance between the electron beams at the location of the deflection unit 51 does not change as a function of the deflection. In FIG. 4, the means 14, 14′ do change this distance, i.e. the means 14 bends the electron beams away from each other, and the means 14′ bends the electron beams in opposite directions. This outward deflection by means 14 is controlled as a function of the deflection such that, e.g. at the corners of the screen (North and North-East), the electron beams are not deflected at all, whereas they are deflected most at the center of the screen. As a result, the distance between the electron beams (pitch) is the smallest at North and North-East, and largest at the center at the plane of deflection (more or less the center plane through the defection means 51). Thus, as a function of the deflection, the pitch decreases from the center of the screen towards the corners. Since the distance P_{gd} decreases, the distance q may increase. The increase of the distance q allows an increase of the curvature of the color selection electrode 11 . This has a positive effect on the strength and doming behavior of the color selection electrode 11.

In accordance with the invention, the means 14 and 14′ are integrated in the electron gun 5. By applying dynamic voltage differences between two or more apertures in subsequent electrodes, with the center line of the apertures in these electrodes being displaced relative to each other, an electric field can be applied which comprises a component at right angles to the direction of movement of the electron beams (in the x-direction), so that the beams are moved towards each other. The means 14 and 14′ are integrated in front of a main lens section (ML). The means 14 is integrated in the prefocusing section (PF) of the electron gun. As a result of the relative displacement of the apertures in the electrodes, the electric field generated, in operation, between the electrodes comprises a component which is transverse to the direction of propagation of the outermost electrodes, so that the convergence of the electron beams is influenced. The dynamic component in the voltage applied between the electrodes causes a dynamic adaptation of the convergence, whereby, in this embodiment of the prefocusing section of the gun, the beams in this section are moved towards each other as a function of the deflection. The second means 14′ is integrated in the electron gun in front of the main lens per se, to which a dynamic voltage is applied.

FIG. 4 shows the relation between the gun pitch P_{gd} (i.e. the distance between the central and outer beams at the deflection plane 91 of the deflection unit), the screen pitch P_{sc} (i.e. the distance between the central and outer beams at the screen 10), the distance L between the deflection plane and the screen, and the distance q between the shadow mask and the screen. As they leave the gun, the three beams 6, 7, 8 are converged on the screen 10. FIG. shows that for a given screen pitch P_{sc} and a given distance L, the distance q increases when the gun pitch P_{gd}, decreases. Mathematically, this relation is given by:

q=(P_{sc}*L)/(3*P_{gd}+P_{sc}).

Consequently, by varying the gun pitch P_{gd} as a function of the deflection, the mask-to-screen distance q can be varied for each point on the screen and an additional curvature of the color selection electrode can be obtained.

FIG. 5 shows schematically an electron gun for a display device in accordance with the invention. The electron gun comprises a prefocusing section PF, which section comprises at least a first (G1) and second prefocusing electrode (G2) each at a fixed potential V_{G1} and VG₂, (these voltages V_{G1} and V_{G2} need not and usually are not the same, and ‘fixed’ within the concept of the invention means ‘not dependent on deflection’), a fixed focusing potential (at a fixed, i.e. non-dynamic potential V_{foc}) section G_{foc} and a main lens section ML, said main lens section having an electrode Gₐ at anode potential Vₐ. An electrode G_{DAF} to which, in operation, a dynamic voltage V_{dyn} is supplied, is arranged between said electrode Gₐ and the fixed focusing potential section. Said electrode G_{DAF} (or more precisely the application of the dynamic voltage V_{dyn} to said electrode) influences the focusing as well as the astigmatism of the main lens section ML. The latter electrode G_{DAF} is electrically connected to an electrode G_{DBF} positioned between the G₂ electrode and the G_{foc} electrode. The voltages applied to the respective electrodes are schematically indicated in the FIG. by V_{dyn} (the dynamic voltage), V_{foc} (the fixed focusing potential) and Vₐ (the anode potential). Example (but not limitatur) values for said voltages for the center (C) of the screen as well as for East (E) are indicated.

A first means 14 for influencing the pitch of the electron beams (corresponding to means 14 in previous FIGS.) is formed between G_{DBF} and G_{foc}. A second means 14′ is formed between G_{foc} and G_{DAF}. In this example for East and North-East (deflection to the left side of the screen, where the same holds for West), V_{DBF}=V_{foc}, hence the outer (red and blue) beams pass normally (indicated by the dashed line ‘E’ in the FIG. ) both in the first means and in the second means. For the center (C) of the screen V, V_{DBF} is lower than V_{foc}, hence the red and blue beams are bent outwards by the first means and inwards by the second. As a result, the distance between the outer beams is larger at the center C than at the side E, so that the distance P_{gd} decreases as a function of the deflection, leading to an increase of q. The advantage of the invention is that the dynamic potential V_{dyn} takes care of two separate functions, on the one hand, dynamic control of focusing and astigmatism (in and just in front of the main lens) and, on the other hand, also dynamic control of the gun pitch. This allows a relatively high-quality image production, while yet with a design which is relatively simple, and also a set-up with which setmakers are relatively familiar. DAF-guns are used at the higher end of the gamma of cathode ray tubes, especially for monitors. This aspect is important because setmakers often demand that any new design is compatible to a large degree with already existing systems.

FIG. 5 shows an embodiment in which two single means are used. It is to be noted that the first onset of a change in the distance (deviation) between the outer electron beams takes place at a position between G_{DBF} and G_{foc} at means 14. Because these first deviations are not effected at the cross-over, convergence errors are introduced: the three beams do not land at the same screen position, due to the deviation (dashed line labelled ‘C’ in the FIG.). The amount of misconvergence is often called the free-fall error (FFE) which is schematically indicated in the FIG. This convergence error is substantially corrected by the second means 14′ between G_{foc} and G_{DAF}. The deviation is dependent on the offset of the apertures in facing electrodes and can be chosen to be such that the FFE introduced by the first means is compensated by the second means. Nevertheless, although the FFE is corrected, it is advantageous that the correction by the second means is relatively small (resulting in a relatively small offset of the apertures in the second means 14′).

FIG. 6A shows a preferred embodiment of the invention. In this embodiment, an intermediate electrode Gᵢₙₜ is positioned between G₂ and G_{DBF}, which electrode is at the fixed focusing potential. Thus, the first means is split into two means 14a and 14b. The point of deviation is placed closer to the cross-over CO resulting in a smaller FFE, and thus in a smaller correction by the second means. In FIG. 6A, this is indicated by a smaller FFE.

Various embodiments fall within the scope of the invention. In some embodiments, the display screen is rectangular with a long and a short axes, and the at least one direction corresponds to the long axes. The single dynamic signal V_{dyn} then has a component which corresponds to (is a function of) the deflection along the long axes. In standard tubes, this is the line (fast) direction. Such embodiments are preferred in standard tubes (i.e. tubes in which the line direction corresponds to the long axes) in which the need for DAF is relatively large, but the need for gun pitch modulation is relatively small. In standard tubes, the need for DAF correction is usually greater along the long (line) axes, and the need for gun pitch modulation is greater along the short (frame) axes. In a further preferred embodiment, the at least one direction corresponds to the long axes, and the line deflection (the fast high-frequency deflection) is along a direction corresponding to the short axes. In such tubes (of the so-called transposed scan, because the scan directions are transposed), the need for DAF correction and gun pitch modulation are both strongest along the long axes, i.e. the slow, frame direction. Thus, in such transposed scan tubes, the above embodiment of the invention can be used very advantageously.

In other embodiments, the display screen is rectangular with a long and a short axes, and the at least one direction corresponds to the short axes. Such embodiments are preferred in standard tubes (i.e. tubes in which the line direction corresponds to the long axes) in which the need for DAF is relatively small but the need for gun pitch modulation is relatively moderate.

In yet other embodiments, the applied dynamic voltage comprises components corresponding to the deflection along the short and long axes, and is directly applied to the main lens, the electric connection between the first and the second dynamic potential electrode including a low-pass filter, inside the tube. Dynamic astigmatism and focusing correction is then done both along the short and the long axes, while gun pitch modulation is done along the long axes.

Such an embodiment is schematically shown in FIG. 6B. The single dynamic voltage V_{dyn} is directly supplied to G_{DAF}. G_{DAF} is electrically connected to G_{DBF} via an internal (i.e. in the tube) low-pass filter 61. As a consequence, astigmatism and focusing is dynamically corrected in the line and frame direction and gun pitch modulation is performed in the frame direction.

FIG. 7 illustrates very schematically the deviations of the outer electron beams. In the design of FIG. 5 (shown in the top part of FIG. 7), the electron beams are deviated by a first means 14 and redirected by a second means 14′. The first deviation takes place at a relatively large distance from the cross-over CO.

In the preferred embodiment of FIGS. 6A and 6B, the first means 14 are split into two means 14a and 14b. The deviation takes place closer to the cross-over CO. The closer said deviation takes place to the cross-over, the better the image reproduction.

FIG. 8 illustrates the free-fall error as a function of the difference between V_{DBF} and V_{foc}. Line 81 corresponds to a design as schematically shown in FIG. 5, lines 82 and correspond to designs as shown schematically in FIG. 6, the difference being slightly different forms for the main lens electrodes. FIG. 8 shows clearly that the free-fall error is substantially less for lines 82 and 83 than for line 81.

FIG. 9 shows the results of experiments in which the relation between the difference in potential V_{DBF}-V_{foc} and V_{DAF}-V_{foc} in order for a compensating effect to occur was investigated. In these experiments, the linearity between these differences was investigated. If a straight line is found (V_{DBF}−V_{foc}=constant*(V_{DAF}−V_{foc})) this means that it is indeed possible to use one and the same dynamic potential for a good result. In a first order approximation, the constant is a function of the offset of the apertures, thus if a linear relationship is found, the offset can be tuned in such a way that the constant is 1. Deviations from a linear relation between the two differences in potential indicate that a good compensation of FFE is obtainable over a small dynamic range, but as the range increases, less than optimal corrections occur. Line 91 corresponds to line 81 in FIG. 8, lines 92 and 93 correspond to lines 82 and 83, respectively. As explained above for line 91, higher differences in V_{DAF}−V_{foc} (all other things being the same) are needed for compensation of the FFE introduced by V_{DBF}−V_{foc}. Typical ranges for dynamic voltages are ±1 Kvolt. Within this range, the linearity of line 91 is approximately good to within 15-20%, whereas for lines 92 and 93 the linearity is good to within approximately 5-10%. This means that a single dynamic voltage V_{dyn} (i.e. V_{dyn}=V_{DBF}−V_{foc}=V_{DAF}−V_{foc}) can be used in both embodiments, but a better result is obtained in the preferred embodiment (FIG. 6, claim 2).

It will be clear that many variations are possible within the framework of the invention.

1. A color display device comprising a color cathode ray tube (1) including an inline electron gun (5) for generating three electron beams (6, 7, 8), a color selection electrode (13) and a phosphor screen (10) on an inner surface of a display window (2), and a means (11) for deflecting the electron beams across the color selection electrode (13), the color display device comprising means (14, 14′) for dynamically influencing the paths of the electron beams so as to decrease, as a function of the deflection in the at least one direction, the distance (P_{gd}) between the electron beams (6, 7, 8) at the location of the deflection plane (20), said means comprising at some distance from each other a first (14) and a second (14′) means for dynamically influencing the distance between the electron beams, the influences of the first (14) and second (14′) means being of opposite sign, characterized in that the electron gun comprises a prefocusing section (PF) comprising at least two electrodes (G₁, G₂) at fixed potentials (V_{G1}, VG₂), a main lens section (ML) having at least a main lens electrode (G_{A}) at anode potential (V_{A}), and a fixed focusing (V_{foc}) potential section (G_{foc}) between the prefocusing section (PF) and the main lens electrode at anode potential (P_{A}), the electron gun comprising a first dynamic potential (V_{dyn}) electrode (G_{DBF}) between the second prefocusing electrode (G₂) and the fixed focusing potential section (G_{foc}) and a second dynamic potential electrode (G_{DAF}) between the fixed focusing potential section (G_{foc}) and the main lens electrode (Gₐ) at anode potential, the first and second dynamic potential electrodes being electrically interconnected, and the display device having means for applying a single dynamic voltage for the first and second dynamic potential electrodes to form the first (14) and second (14′) means for dynamically influencing the distance between the electron beams at the plane of deflection, the second means also dynamically influencing focus and astigmatism of the main lens.

2. A color display device as claimed in claim 1, characterized in that the display screen is rectangular with a long and a short axes, and the at least one direction corresponds to the long axes.

3. A color display device as claimed in claim 2, characterized in that the line deflection is along a direction corresponding to the short axes.

4. A color display device as claimed in claim 1, characterized in that the display screen is rectangular with a long and a short axes, and the at least one direction corresponds to the short axes.

5. A color display device as claimed in claim 1, characterized in that the applied dynamic voltage comprises components corresponding to the deflection along the short and long axes, and is directly applied to the main lens, the electric connection between the first and the second dynamic potential electrode including a low-pass filter, inside the tube.

6. A color display device as claimed in claim 1, characterized in that the electron gun comprises, between the first dynamic potential electrode (G_{DBF}) and the second electrode at fixed potential of the pre-focusing section (G₂), an intermediate electrode (Gᵢₙₜ) which, in operation, is at the same potential as the fixed focusing potential section (V_{foc}), a multiple of pitch-influencing means (14a, 14b) being formed between the intermediate electrode, the first dynamic potential electrode and the fixed focusing potential section.
